(19) United States
(12) Patent Application Publication
(10) Pub. No.: US 2015/0067749 A1
(43) Pub. Date: Mar. 5, 2015

(54) METHOD AND APPARATUS FOR PROVIDING EXTENDED TV DATA

(71) Applicant: Michael Huber, Sundyberg (SE)

(72) Inventor: Michael Huber, Sundyberg (SE)

(73) Assignee: Telefonaktiebolaget L M Ericsson (PUBL), Stockholm (SE)

(21) Appl. No.: 14/391,684

(22) PCT Filed: Apr. 13, 2012
(86) PCT No.: PCT/EP2012/056775

§ 371 Date: Oct. 9, 2014

(51) Int. Cl. H04N 21/235; H04N 21/435; H04N 21/236

(52) U.S. Cl. CPC H04N 21/2358; H04N 21/23614; H04N 21/2353; H04N 21/4358
USPC 725/110

(57) ABSTRACT

There is provided a data stream for receipt by a receiving device. The data stream comprises at least one program stream; and an extended data descriptor. The extended data descriptor comprises extended data for an auxiliary device, the extended data relating to a particular program stream and defining information to be output by the auxiliary device when the particular program stream is output by the receiving device.

### TECHNICAL FIELD

The present application relates to a data stream for a receiving device, a receiving device, an encoder, a method for creating a data stream, and a computer-readable medium.

### BACKGROUND

Television (TV) programming may be delivered to a receiving device by a variety of means. Delivery mechanisms in use today include terrestrial broadcast, satellite broadcast, cable, and IPTV (internet protocol television, which can be delivered via an IP network). Historically, analogue transmission schemes were used, but increasingly digital transmission schemes are displacing these. Digital transmission schemes typically follow the Digital Video Broadcasting (DVB) standards. Regardless of the delivery mechanism, a receiving device receives and decodes the transmission signal. The receiving device can be incorporated into a display (a television) or may be arranged to be connected to a display device (a set-top box, STB).

Many TV viewers have access to smart phones and tablet devices, and the viewers like to use these while watching TV programs. A typical use of such a device while watching TV may be to access a website to find the name of an actor, or other programs the actor has been in. Further, some users like to use social networking sites to discuss a currently shown program with their peers.

A problem with such usage of auxiliary devices is that it diverts the user's attention away from the TV program they are trying to watch. This can result in the user becoming quickly frustrated when it is difficult to locate the information they are looking for, such as a database listing of the exact program they are watching, or the preferred forum for online discussion.

Further, content producers and distributors may wish to take advantage of this trend of auxiliary content access in order to provide interaction with the viewing audience. However, to do this the viewers must be directed users to a website of the content producer's or distributor's choice. Presently, the only way to do this is to display a website address on the screen, which is both a distraction for users not interested in the auxiliary content, and an inefficient means of communication for those that are.

Accordingly, there is a need for an improved method and apparatus for providing extended TV data.

### SUMMARY

There is provided a data stream for a receiving device. The data stream comprises at least one program stream and an extended data descriptor. The extended data descriptor comprises extended data for an auxiliary device, the extended data relating to a particular program stream and defining information to be output by the auxiliary device when the particular program stream is output by the receiving device.

By including an extended data descriptor in a data stream, a receiving device can make extended data available to an auxiliary device, the extended data controlled by the program producer of distributor. The extended data may thus be targeted to the particular program. An incompatible receiver may ignore the extended data descriptor. The program stream may be a media stream; the media stream may comprise a video stream and an audio stream.

The extended data descriptor may comprise a link to a resource available to the auxiliary device. The resource may be available locally, from a private source, or from a public source. The resource may be retrieved from the receiving device, from another device on a local network, or from the internet. The link to a resource may be a link to: text, graphical information, audio information, or video information.

The extended data descriptor may comprise information for display by the auxiliary device. The information may comprise text, graphical information, audio information, or video information.

The extended data descriptor may further include an indication of the time for which the extended data is valid. If the program is recorded the extended data can be recorded also, the data will not be shown to the user if the particular program is played back after the valid time has expired. This will prevent the auxiliary device from attempting to show extended data that is no longer available or no longer relevant to the particular program.

The extended data descriptor may be repeated within the data stream. The extended data descriptor may be repeated within the data stream several times a second.

The data stream may be a transport stream. The transport stream may be an MPEG2 transport stream. The extended data descriptor may be included in a Program Association Table (PAT), a Program Map Table (PMT), or a private data packet. The PAT or PMT may be a part of an MPEG data stream. The extended data descriptor may be pointed to by the PAT or PMT. The extended data descriptor may be included in a new table.

The extended data descriptor may be included within one of the program streams.

The data stream may be an adaptive stream, and the extended data descriptor may be included within a manifest. The adaptive stream may be an HTTP adaptive stream.

There is further provided a receiving device for receiving a data stream, the receiving device comprising a receiver, a processor and a first and a second output. The receiver is arranged to receive a data stream comprising both at least one program stream and at least one extended data descriptor. The extended data descriptor comprises extended data for an auxiliary device, the extended data relating to a particular program stream. The processor is arranged to decode the particular program stream, and to decode the extended data descriptor relating to the particular program stream. The first output is arranged to output the particular program stream. The second output is arranged to output the extended data to an auxiliary device.

Decoding the extended data may comprise extracting the extended data from the extended data descriptor.

The first output may comprise a video display that is part of the device or a connection for a video display screen to be connected to the device. The first output may further comprise a speaker that is part of the device or a connection for an audio component to be connected to the device. The second output may comprise a network connection, which may be wired or wireless. The second output may be a Bluetooth™ connection.

The receiving device may be further arranged to: receive a connection request from an auxiliary device; and establish a connection with the auxiliary device.

Once a connection is established with the auxiliary device, the receiving device serves extended data to the auxiliary device. The establishment of a connection may require an authentication mechanism such as a code displayed on a display connected to the receiving device, the code for input by a user into the auxiliary device. The connection between the receiving device and the auxiliary device may be made over the internet, or over a local network. Both the receiving device and the auxiliary device may establish a connection to each other, connections to a network or connections to the internet. The connections may be over a wired or a wireless link.

There is further provided an encoder. The encoder is arranged to receive at least one program stream. The encoder is further arranged to receive extended data related to at least one of the received program streams. The encoder is arranged to encode the at least one program stream, and to encode the extended data in an extended data descriptor. The encoder is further arranged to combine the encoded data to generate a data stream. The data stream may comprise the encoded at least one program stream and the extended data descriptor.

There is provided a further encoder. The encoder is arranged to receive an encoded data stream comprising at least one program stream. The encoder is further arranged to receive extended data related to at least one of the received program streams. The encoder is further arranged to encode the extended data in an extended data descriptor, and to insert the extended data descriptor into the data stream.

There is further provided a method for creating a data stream including an extended data descriptor. The method comprises receiving at least one program stream and encoding the at least one program stream to generate a data stream. the method further comprises receiving extended data related to at least one of the received program streams, and encoding the extended data in an extended data descriptor. The method further comprises inserting the extended data descriptor into the data stream.

There is further provided a computer-readable medium, carrying instructions, which, when executed by computer logic, causes said computer logic to carry out any of the methods defined herein. There is further still provided a computer-readable storage medium, storing instructions, which, when executed by computer logic, causes said computer logic to carry out any of the methods defined herein

### BRIEF DESCRIPTION OF THE DRAWINGS

An improved method and apparatus for providing extended TV data will now be described, by way of example only, with reference to the accompanying drawings, in which:

FIG. 1 illustrates a system for providing extended TV data;

FIG. 2 illustrates an example data stream;

FIG. 3 illustrates an mpeg transport stream;

FIG. 4 illustrates a receiving device for receiving a data stream including an extended data descriptor;

FIG. 5 illustrates a method for creating a data stream including an extended data descriptor;

FIG. 6 illustrates an encoder arranged to receive at least one program stream;

FIG. 7 illustrates an alternative arrangement comprising two encoders; and

FIG. 8 illustrates an example encoder suitable for performing the encoding tasks described herein.

### DETAILED DESCRIPTION

According to the method and apparatus disclosed herein, an extended data descriptor is inserted into a data stream that contains at least one program stream. The extended data descriptor is used by the receiving device to provide an extended data service to an auxiliary device.

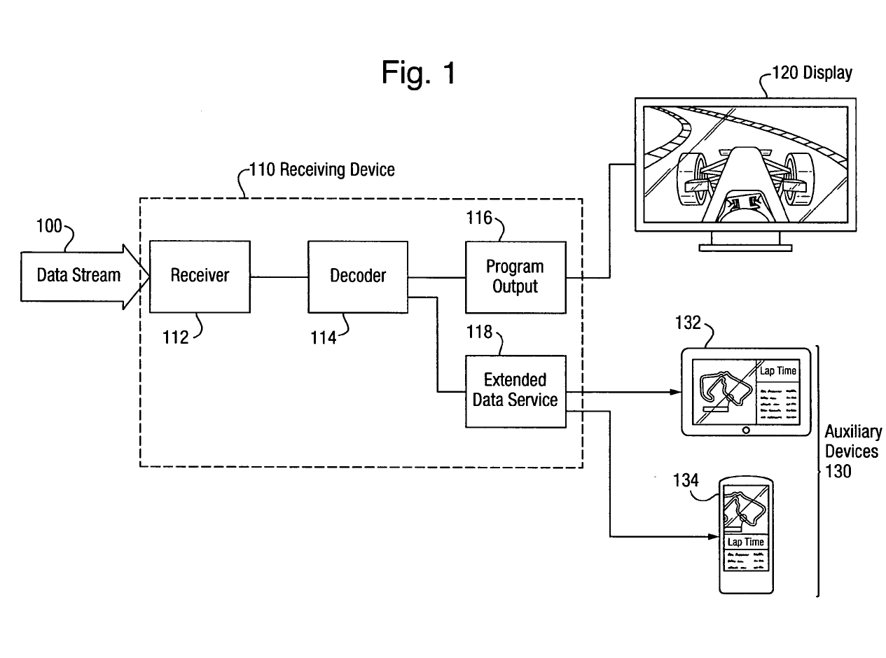

FIG. 1 illustrates a system for providing extended TV data. A receiving device 110 receives a data stream 100. Data stream 100 includes both at least one program stream and an extended data descriptor related to a particular program stream in the data stream 100. The receiving device comprises a receiver 112, a decoder 114, a program output 116 and an extended data service 118. The data stream 100 is received at the receiver 112 and then decoded by the decoder 114. A decoded program is output at the program output 116 to a display 120, which may or may not be a part of the receiving device 110. The decoder 114 also decodes the extended data descriptor and if there is extended data associated with the output program, then this is made available to auxiliary devices 130 via the extended data service 118. Auxiliary device 130 may comprise any appropriate communications device; FIG. 1 shows two examples, a tablet 132 and a smartphone 134.

In the example of FIG. 1 a car race is being shown, with the program stream comprising regular edited programming, in this instance an on-board view from one of the cars, displayed on display 120. The extended data shown on the auxiliary devices 130 comprises: a representation of the track with an indicator showing the current position on the track of the car from which the on-board view is being taken; and a list of the latest lap times of the some of the cars. This extended data has been created by the content producer to enhance the viewing experience.

Data stream 100 may contain multiple program streams, such as a typical broadcast multiplex wherein each data stream comprises a multiplex of different program streams. Any of the program streams within a multiplex may have extended data associated therewith. Where a plurality of programs in the data stream have extended data associated therewith, the extended date may be encoded in separate extended data descriptors, or within the same extended data descriptor.

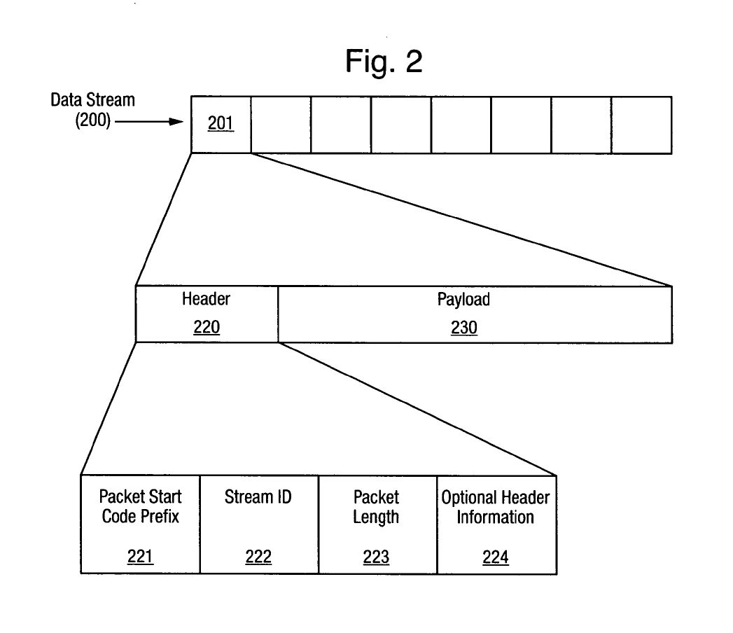

The extended data descriptor is inserted into the data stream containing the program streams. An example data stream 200 is shown in FIG. 2. The data stream 200 comprises a series of packets 201. Each packet 201 comprises a header 220 and a payload 230. The header 220 comprises a packet start code prefix 221, a stream ID 222, a packet length indicator 223, and any optional header information 224.

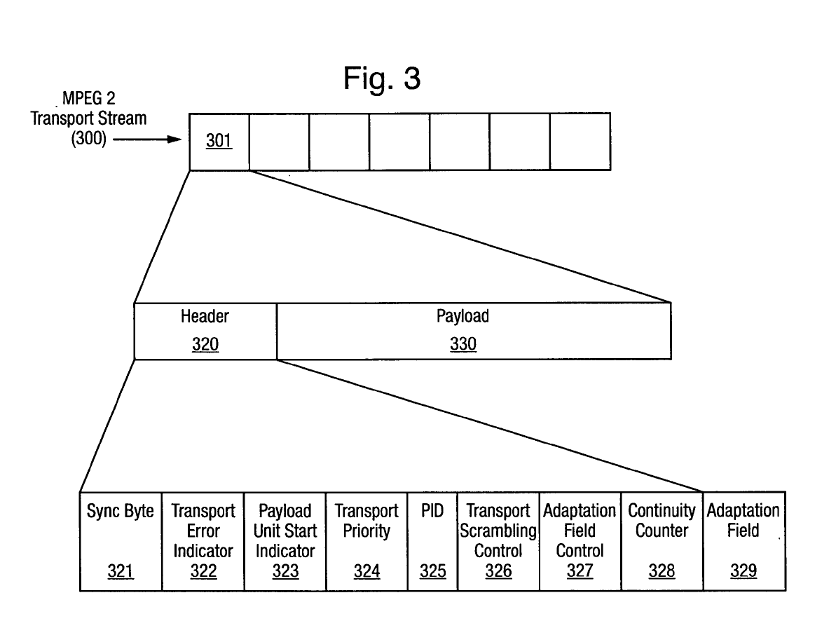

Below, reference is made to the mpeg (Moving Picture Experts Group) transport stream to illustrate an example implementation. An mpeg transport stream 300 is illustrated in FIG. 3. The transport stream 300 comprises a series of packets, 301, each having 188 bytes. Each packet 301 comprises a 4-byte header 320 and a 184-byte payload 330. The header 320 comprises a sync byte 321, a transport error indicator 322, a payload unit start indicator 323, a transport priority 324, a packet identifier 325, a transport scrambling control 326, an adaptation field control 327, a continuity counter 328, and an adaptation field 329.

Mpeg transport streams are used to transport video, audio and text packets in IPTV as well as terrestrial, satellite and cable TV digital broadcast networks. The payload of a transport stream packet is normally used for video or audio payload. Some packets comprise other payload information like the PAT (Program Association Table) and the PMT (Program Map Table) are used to keep track of the different packet types in a stream.

To keep track of different types of packets, a unique packet identifier is assigned for each service. For example:

| Packet name | Packet ID (PID) |
|---|---|
| PAT (Program Association | 0 |
| Table) | |
| PMT (Program Map Table) | 101 |
| Video | 201 |
| Audio | 301 |

Some packets inside the stream, like PAT, have a hard coded PID (Packet ID), while others have dynamically assigned PIDs. The PAT (Program Association Table) is the first entry point for dynamically assigned PIDs and it points out one or more PMTs. A PMT keeps track of the programs different audio, text and video elements. Different standards have different hard coded PIDs. For example, in DVB, PID 12 is an Event Information Table (EIT) that is hard coded, while in ATSC PID 12 does not necessarily refer to EIT.

The extended data descriptor that is added into the data stream or the transport stream can be added as a descriptor inside one of the existing tables or it can be added as a private data package on its own PID, either hardcoded or dynamically added inside the stream.

The extended data descriptor should be added at least once per second, and preferably a couple of times a second in a live stream that people can join and leave as they please.

An embodiment of the extended data descriptor described herein is composed as follows:

```
Extended stream data package
{
    Header:
      Type of data <ex, url, raw data, application specific...>
      Target application < For what application is this data for>
      Valid time <Will this data be valid in timeshift / recording?
Or only now>
      Payload data index <If payload is bigger then one package it
need to reassemble on the client side>
      Payload size
    Payload:
      Raw data
}
```

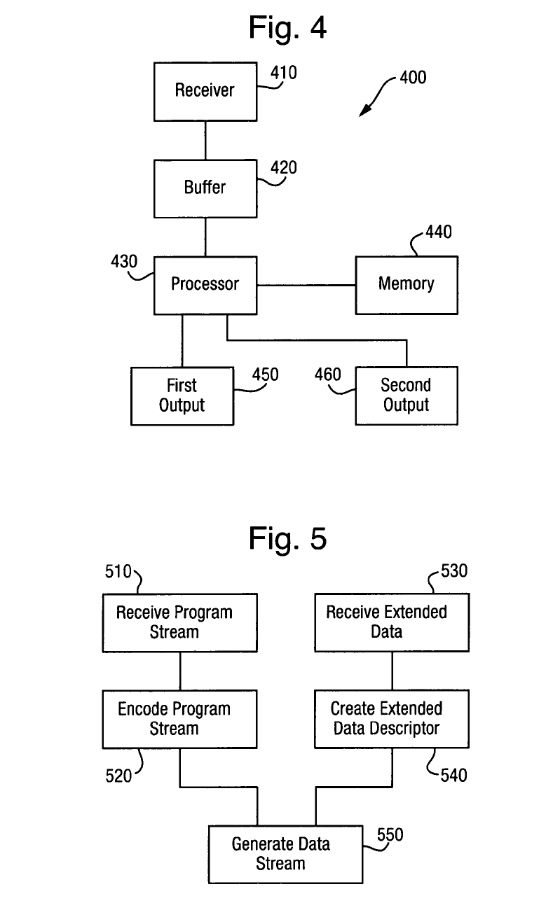

FIG. 4 illustrates a receiving device 400 for receiving a data stream including an extended data descriptor as described above. The receiving device 400 comprises a receiver 410, a buffer 420, a processor 430, a memory 440, a first output 450, and a second output 460.

In operation, the receiver 410 receives the encoded data stream and stores this in a buffer 420. The processor 430 reads the data stream from the buffer 420 and decodes the appropriate components of the data stream. The processor 430 is arranged to receive instructions which, when executed, cause the processor 430 to carry out the above described method. The instructions are stored on the memory 440. During decoding, the processor 430 receives the extended data descriptor and determines what, if any, of the extended data should be made available as an extended data service. The decoded program is sent to an output 440. The outputting may comprise displaying on a video display that is part of the device 400 or a video display screen that is connected to the device 400. The extended data service is provided by a second output 460. The second output 460 may connect the receiving device to a network which auxiliary devices can also connect to, or the second output 460 may comprise a connection to the auxiliary devices via a communication protocol such as a Bluetooth™′

FIG. 5 illustrates a method for creating a data stream including an extended data descriptor. The method comprises receiving 510 at least one program stream which may comprise a video and/or an audio stream. The method further comprises encoding 520 the at least one program stream. The method further comprises receiving 530 extended data, and encoding 540 the extended data in an extended data descriptor. The method further comprises combining the extended data descriptor with the at least one encoded program stream to generate 550 the data stream.

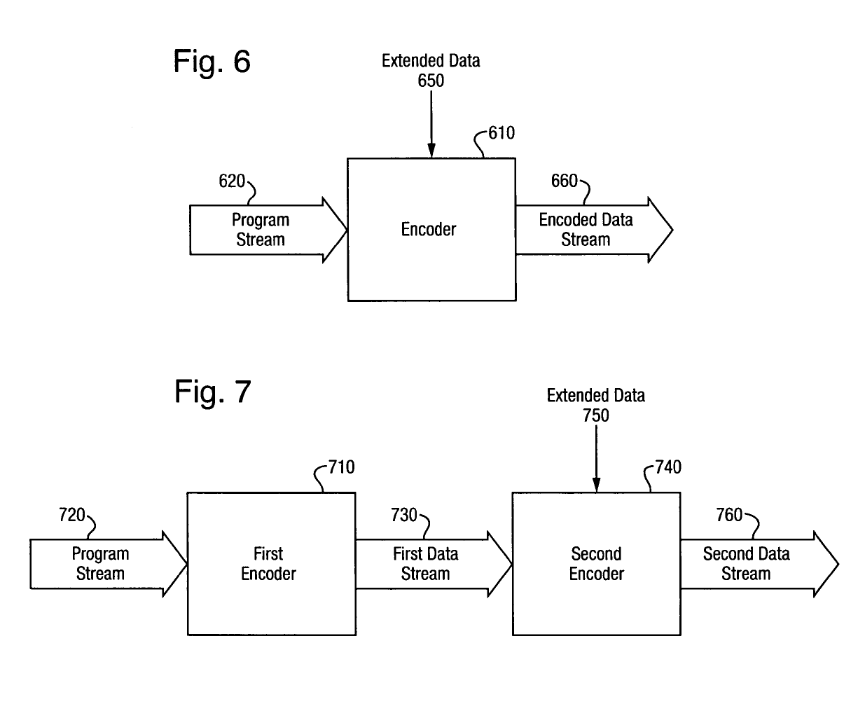

It should be noted that the encoding of the extended data may be performed in a different server to that which the at least one program stream is encoded. That is, a first data stream comprising the encoded at least one program stream is created in one server, sent to a second server which also receives the extended data, and in which the extended data descriptor is created and inserted into the first data stream to generate a second data stream, which includes both the at least one program stream and the extended data. These two alternatives are shown in FIGS. 6 and 7.

FIG. 6 shows an encoder 610 arranged to receive at least one program stream 620. The encoder 610 also receives extended data 650 relevant to at least one of the received program streams 620. The encoder 610 encodes the program streams and the extended data to create an encoded data stream 660.

As an alternative to the arrangement of FIG. 6, FIG. 7 illustrates two encoders, 710 and 740. The first encoder 710 is arranged to receive at least one program stream 720. The first encoder 710 encodes the program streams to create a first data stream 730. A second encoder 740 receives the first data stream 730 and also receives extended data 750. The second encoder 740 encodes the extended data and inserts it into the first data stream 730 to create a second data stream 760. The first encoder 710 and the second encoder 760 may reside in different servers.

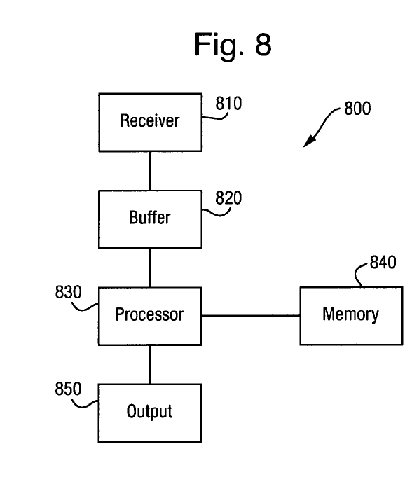

FIG. 8 illustrates an example encoder 800 suitable for performing the encoding tasks of encoders 610, 710 and 740 described above. The encoder 800 comprises a receiver 810, a buffer 820, a processor 830, a memory 840, and an output 850.

In operation, the receiver 810 receives the information for encoding (such as program streams and/or extended information) and stores this in a buffer 820. The processor 830 reads the information for encoding from the buffer 820 and encodes this to generate a data stream. The processor 830 is arranged to receive instructions which, when executed, cause the processor 830 to carry out the above described method. The instructions are stored on the memory 840. The encoded data stream is sent to an output 850. The outputting may comprise sending the encoded data stream to a distribution node such as a transmitter from which the stream may be broadcast.

Advantageously, if a receiver cannot interpret the extended data descriptor, then it will be ignored. As such the receiver will still be able to access the program streams, and to output these. The solution described herein provides a solution for a content creator or head end operator to communicate with end users' auxiliary devices in a unified way. Further, the solution described herein provides an extended data for an auxiliary device that is bundled together with a program stream into one package that can be accepted by all parts in the transmission chain, and that is independent of the distribution network.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

While examples have been given in the context of particular communications standards, these examples are not intended to be the limit of the communications standards to which the disclosed method and apparatus may be applied. For example, while specific examples have been given in the context of MPEG transport streams, the principles disclosed herein can also be applied to any other video transport standard which uses content streams.

Further, while examples have been given in the context of a particular communications network, these examples are not intended to be the limit of the communications networks to which the disclosed method and apparatus may be applied. The principles disclosed herein can be applied to any communications network which carries media using streaming, including both wired IP networks and wireless communications networks such as LTE and 3 G networks.

Where reference is made to HTTP Adaptive Streaming, these references are not intended to be the limit of streaming system to which the disclosed method and apparatus may be applied. The principles disclosed herein can be applied to any streaming system which uses a description file. For example, this method and apparatus may be applied to Apple™ HTTP Live Streaming, and Microsoft™ Smooth Streaming.

1. A data stream for a receiving device, the data stream comprising:
at least one program stream; and
an extended data descriptor, wherein the extended data descriptor comprises extended data for an auxiliary device, the extended data relating to a particular program stream and defining information to be output by the auxiliary device when the particular program stream is output by the receiving device.

2. The data stream of claim 1, wherein the extended data descriptor comprises a link to a resource available to the auxiliary device.

3. The data stream of claim 1, wherein the extended data descriptor comprises information for display by the auxiliary device.

4. The data stream of claim 1, wherein the extended data descriptor further includes an indication of the time for which the extended data is valid.

5. The data stream of claim 1, wherein the extended data descriptor is repeated within the data stream.

6. The data stream of claim 1, wherein the data stream is a transport stream.

7. The data stream of claim 6, wherein the extended data descriptor is included in a Program Association Table, a Program Map Table, or a private data packet.

8. The data stream of claim 1, wherein the extended data descriptor is included within one of the program streams.

9. The data stream of claim 1, wherein the data stream is an adaptive stream and the extended data descriptor is included within a manifest.

10. A receiving device for receiving a data stream, the receiving device comprising:
a receiver arranged to receive a data stream comprising both at least one program stream and at least one extended data descriptor, wherein the extended data descriptor comprises extended data for an auxiliary device, the extended data relating to a particular program stream;
a processor arranged to decode the particular program stream, and to decode the extended data descriptor relating to the particular program stream;
a first output arranged to output the particular program stream; and
a second output arranged to output the extended data to an auxiliary device.

11. The receiving device of claim 10, further arranged to:
receive a connection request from an auxiliary device; and
establish a connection with the auxiliary device.

12. An encoder arranged to:
receive at least one program stream;
receive extended data related to at least one of the received program streams;
encode the at least one program stream;
encode the extended data in an extended data descriptor; and
combine the encoded data to generate a data stream.

13. An encoder arranged to:
receive an encoded data stream comprising at least one program stream;
receive extended data related to at least one of the received program streams;
encode the extended data in an extended data descriptor; and
insert the extended data descriptor into the data stream.

14. A method for creating a data stream including an extended data descriptor, the method comprising:
receiving at least one program stream;
encoding the at least one program stream to generate a data stream;
receiving extended data related to at least one of the received program streams;
encoding the extended data in an extended data descriptor; and
inserting the extended data descriptor into the data stream.

15. A non-transitory computer-readable medium, carrying instructions, which, when executed by computer logic, causes said computer logic to carry out the method defined by claim 14.
